(19) United States
(12) Patent Application Publication
(10) Pub. No.: US 2014/0268838 A1
(43) Pub. Date: Sep. 18, 2014

(54) MODEL AIRPLANE ILLUMINATION SYSTEM

(71) Applicants: Roger Kimball, Reunion, FL (US); Alexander Stephens, Reunion, FL (US); Jennifer Kimball, Reunion, FL (US)

(72) Inventors: Roger Kimball, Reunion, FL (US); Alexander Stephens, Reunion, FL (US); Jennifer Kimball, Reunion, FL (US)

(21) Appl. No.: 13/798,327

(22) Filed: Mar. 13, 2013

(51) Int. Cl. B64D 47/02

(52) U.S. Cl. CPC B64D 47/02
USPC 362/470

(57) ABSTRACT

A model airplane illumination system is disclosed. The system includes a plurality of carbon fiber wingtip conduits, a wingtip mount configured to secure at least one of the wingtip conduits substantially perpendicular to each wingtip of a model airplane, and a plurality of light emitting diodes (“LED”), where at least one LED of the plurality of LEDs is secured to each end of the wingtip conduit and configured to illuminate surfaces of the model airplane. In addition, the system includes a carbon fiber tail rod, a tail mount configured to secure the tail rod to a tail of the airplane and configured to illuminate the surfaces of the airplane, and at least one LED of the plurality of LEDs is secured to each end of the tail rod and configured to illuminate the tail and fuselage surfaces of the model airplane.

### I. FIELD

The present disclosure is generally related to a model airplane illumination system.

### II. DESCRIPTION OF RELATED ART

Various forms of lights have been used with radio controlled (“RC”) model airplanes so that the pilot can visually see the model airplane at night. For example, this includes attaching individual LEDs to the airplane so that the pilot can use the dots of light from the LEDs to direct the flight path of the model airplane. Similarly, arrays of LEDs or electroluminescent glow wire or chemical light sticks may be secured to the airplane to outline the airplane with light. However, the existing illumination systems do not illuminate the airplane itself to make the airplane visible. Instead the lights are directed outward away from the airplane and towards the pilot on the ground. Thus, the pilot is not visually viewing the RC airplane as it is flying but rather the pilot is flying the lights, which takes away from the enjoyment of flying a RC model airplane.

Accordingly, what is needed in the art is an illumination system that is configured to illuminate the RC model airplane surfaces so that the pilot can visually observe the airplane in low light conditions without impacting the aerodynamics of the airplane.

### III. SUMMARY

In a particular embodiment, a model airplane illumination system is disclosed. The system includes a plurality of wingtip conduits, a wingtip mount configured to secure at least one of the wingtip conduits substantially perpendicular to each wingtip of a model airplane, and a plurality of light emitting diodes (“LED”), where at least one LED of the plurality of LEDs is secured to each end of the wingtip conduits and configured to illuminate surfaces of the model airplane. In addition, the system includes a tail rod, a tail mount configured to secure the tail rod to a tail of the airplane and configured to illuminate the surfaces of the airplane, and at least one LED of the plurality of LEDs is secured to each end of the tail rod and configured to illuminate the tail and fuselage surfaces of the model airplane.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is an elevational view of a particular embodiment of a model airplane illumination system;

FIG. 2 is a front view of a wingtip conduit and LEDs of the illumination system shown in FIG. 1;

FIG. 3 is a rear view of the wingtip conduit and the LEDs;

FIG. 4 is an elevational view of the wingtip conduit and LEDs of the illumination system shown in FIG. 1;

FIG. 5 is a detailed perspective view of the LED shown in FIG. 4;

FIG. 6 is an elevational schematic view of the illumination system installed on a radio controlled model airplane;

FIG. 7 is a top schematic view of the illumination system installed on the radio controlled airplane shown in FIG. 6; and

FIG. 8 is a perspective view of the illumination system installed on the radio controlled airplane.

### V. DETAILED DESCRIPTION

A model airplane illumination system according to a particular embodiment is shown in FIG. 1. The illumination system is adapted to be removably attachable to radio controlled model airplane to facilitate illumination of the airplane surfaces. The illumination system includes a wingtip conduit 102, and light emitting diodes (“LEDs”) 104 secured proximate to each end of the wingtip conduit 102. The wingtip conduit 102 may be carbon fiber or any material that is relatively lightweight and substantially rigid. The wingtip conduit 102 may be hollow or otherwise configured to house electrical wiring in electrical communication with the LEDs 104 in a particular embodiment. The relatively thin wingtip conduit 102 mitigates obscuration of the illuminated airplane when viewed in flight from the ground and provides a sturdy support with limited aerodynamic drag.

The LEDs 104 may be secured to a heat sink 122 where the heat sink 122 may include a series of fins 115. The heat sink 122 may be secured to the LEDs 104 using mechanical means such as screws or using an adhesive such as epoxy, polyester film, fiberglass, or polyamide, for example. In a particular embodiment, the system includes high optical output LEDs that exhibit a white light spectrum. Such LEDs typically are of two categories, RGB clusters or phosphor-based LEDs. RGB clusters comprise tight collections of LEDs that emit red, green, and blue light, respectively, in close proximity, thereby producing a composite white light output. Phosphor-based LEDs comprise LEDs of one color (mostly blue LEDs made of InGaN) coated with phosphors that emit different colors to form white light; the resultant LEDs are called phosphor-based white LEDs. LEDs of specific colors may also be used with the system. In addition, the LEDs 104 are mounted to the heat sink 122 with maximum air exposure so that adequate heat dissipation is achieved by convective air flow during airplane flight. The LEDs 104 may be 20 watt to 50 watt super bright LEDs having at least a 140 viewing angle, for example.

In a particular embodiment, the illumination system may include an LED 104 attached proximate to each end of the wingtip conduit 102. The wingtip conduit 102 is adapted to be secured perpendicular to a wingtip of a model airplane using a wingtip mount 134 or adhesive. The wingtip mount 134 may be a bracket that is secured to the wingtip to removably secure the wingtip conduit 102 in place.

The illumination system may also include a tail rod, and LEDs secured proximate to each end of the tail rod. The tail rod (not shown) may be carbon fiber or any material that is relatively lightweight and substantially rigid and may be as small as a few millimeters in diameter in a particular embodiment. Similar to the wingtip conduits 102, the relatively thin tail rod mitigates obscuration of the illuminated airplane with limited aerodynamic drag. An LED 104 may be secured to each end of the tail rod using a substrate such as epoxy, polyester film, fiberglass, or polyamide, for example.

The wingtip conduits 102 are configured to be removed from the model airplane when not needed, such as for daytime flying. The LEDs 104 on one end of the wingtip conduit 102 are configured to primarily illuminate an upper surface of the wings of the model airplane, and LEDs 104 on the opposing end of the wingtip conduit 102 illuminate a lower surface of the wings. The LEDs 104 on the tail rod illuminate the tail section and fuselage of the airplane.

The wiring harness 110 and connections for a particular embodiment of the illumination system is shown in FIG. 1. The LEDs 104 are configured to be attached to the right wing tip, left wing tip, and tail of the model airplane. Each of the LEDs is in electrical communication to the LED driver modules 108 by the electrical wiring harness 110. The wiring harness 110 may be split into parallel connections using connector 120 that is in electrical communication with an electronic speed control (“ESC”) and the driver module 108.

A power source 116 is electrically connected to the LEDs 104 using connectors 112 and the wiring harness 110. In a particular embodiment, the power source 116 is a rechargeable battery. For example, a rechargeable lithium polymer (“LiPo”) battery. LiPo batteries exhibit relatively low weight and high power density. These batteries are usually composed of several identical secondary cells in parallel to increase the discharge current capability, and are often available in series “packs” to increase the total available voltage. Hence, they can be configured to match the needs of the lighting system as larger airplane models demand greater illumination power. The use of other varieties of rechargeable batteries may also be used with the system. Electricity is selectively supplied from the power source 116 to illuminate the LEDs 104 in response to certain predetermined conditions dependent upon the particular application. While FIG. 1 shows one LED 104 mounted to each end of the wingtip conduit 102, it should be appreciated that any number of LEDs 104 may be implemented in a similar manner or a continuous length of LED light strip substrate may be mounted along the length of the wingtip conduit 102 instead of individual LEDs 104.

The electrical connectors 112, 118 and 120 each include a first end that mates with a second end so that the LED driver 108 and power supply 116 can be easily connected and disconnected from the system. In particular, the wingtip conduits 102 can be easily removed from the airplane when not needed by pulling the connectors 112 apart and the wiring harness 110, LED driver 108 and power supply 116 can remain installed in the airplane.

A front view of the LED 104 is shown in FIG. 2. Electrical wires 126, 128 exit the wingtip conduit 102 and are attached to a mounting plate 107 of the LEDs 104 by solder connections or other electrical connections. A rear view of the heat sink 122 is shown in FIG. 3, where the fins 115 are used to dissipate heat generated by the LED 104. The wingtip conduit 102 may be inserted through one of the fins 115 and secured in place using mechanical means such as screws or using an adhesive such as epoxy, polyester film, fiberglass, or polyamide, for example. The LED 104 may be a super bright 20 watt to 50 watt type light emitting diode. The wingtip conduit 102 houses the electrical wires 126, 128 that are in electrical communication with the mounting plate 107 and LEDs 104 and the wires 126, 128 exit the wingtip conduit 102 through an open end. Accordingly, the wires 126, 128 are protected within the wingtip conduit 102.

FIG. 4 is an elevational view of the wingtip conduit 102 and LEDs 104 of the illumination system shown in FIG. 1. The fins 115 serve to dissipate heat and allow air flow between each fin 115. As described above, the wingtip conduit 102 passes through the fins 115 and is secured in place. The wingtip conduit is used to house or encapsulate the wires 126, 128 leading to the respective LED 104 and wingtip conduit 102 in a snug and aerodynamically-favorable geometry. Accordingly, as the model airplane 132 is flying, the wingtip conduits 102 do not interfere with the aerodynamic performance of the airplane 132 due to the rounded surfaces of the wingtip conduits 102 housing or encapsulating the wiring 126, 128 to the LEDs 104.

The wingtip conduits 102 may be attached to the wingtips 140 of the model airplane 132 using a mounting bracket 134, as shown in FIG. 5. For example, the bracket 134 may be secured substantial equidistant from each end of the wingtip conduit 102. A pair of holes 142 may be drilled into the wingtip 140 of the model airplane 132 and a pair of threaded inserts slid and secured into the holes 142. A pair of bolts 136 may then be used to secure the mounting bracket 134 and wingtip conduit 102 to the wingtip 140. Accordingly, in this particular embodiment the wingtip conduits 102 may be easily installed and also removed using the bolts 136.

Referring now to FIG. 6, an elevational schematic of the illumination system installed in the model airplane 132 is shown. The wingtip conduit 102 is generally secured perpendicular to the wings of the airplane 132 so that an upper LED 104 illuminates an upper surface of the wing and a lower LED 104 illuminates a lower surface of the wing of the airplane 132. The LEDs 104 secured to the ends of the wingtip conduit 102 are in electrical communication with the LED drivers 108 and the power source 116. The LEDs 104 that may be secured to the tail rod (not shown) may also be in electrical communication with the LED drivers 108 and the power source 116. In a particular embodiment, a small brushed electronic speed control (“ESC”) may be used with a wireless receiver (not shown) aboard the model airplane 132. For example, the ESC may be in electrical communication with the on-board power source 116 and the LED driver module 108, which is connected to the wireless radio receiver aboard the model airplane 132 that is used to control the flight of the airplane 132. Accordingly, the ESC can be used to remotely adjust the current to the LEDs 104 based on the control input. A proportional control channel having a slider control on the radio control transmitter may be used to allow the pilot to remotely adjust the brightness of the LEDs 104. The channel may also be used to turn the LEDs on and off.

A top schematic view of the illumination system shown in FIG. 7 illustrates the location of the wingtip conduits 102 at the model airplane wingtips. The power supply 116 is generally located within a centerline of the airplane 132 and is in electrical communication with the LED driver modules 108. The wingtip mounts 134 are used to secure the wingtip conduits 102 to the wingtip of the airplane 132 as described above. Accordingly, the wingtip mounts 134 allow the pilot to easily remove the wingtip conduits 102 when not needed. The wingtip conduit mounts 134 may be brackets, spring loaded clips, friction fit, press fit, tension, or any similar mechanical means. The wingtip conduits 102 may also be taped, glued, or cemented to the wingtip of the airplane 132.

The illumination system is shown installed on a model airplane in FIG. 8. The wingtip conduits 102 are installed perpendicular to the wings of the airplane 132. The LEDs 104 are configured to illuminate both the upper surface and lower surfaces of the wings. Accordingly, as the pilot is operating the airplane 132 from the ground, the airplane 132 is illuminated and visible at all times even when the airplane 132 may be rotating while performing aerobatics. If desired, the tail rod may be secured perpendicular to the airplane fuselage and in front of the tail section. However, the tail rod may be secured behind the tail section or on the upper surface of the fuselage proximate the tail section or any other configuration that is desired by the pilot. The wingtip mounts 134 secure the wingtip conduits 102 to the wings of the airplane 132. In another particular embodiment, the wingtip conduits 102 may be rotated about the wingtip mounts 134 and secured to any angle relative to the wings of the airplane rather than perpendicular to the wings.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A model airplane illumination system, the system comprising:
at least one wingtip conduit adapted to house electrical wiring;
a wingtip mount configured to secure the at least one wingtip conduit substantially perpendicular to a wingtip of a model airplane; and
a plurality of light emitting diodes (“LED”), wherein at least one LED of the plurality of LEDs is secured to each end of the at least one wingtip conduit and configured to illuminate surfaces of the model airplane.

2. The illumination system of claim 1, further comprising:
a tail rod;
a tail mount configured to secure the tail rod to a tail of the airplane and configured to illuminate the surfaces of the airplane; and
at least one light emitting diode (“LED”) of the plurality of LEDs is secured to each end of the tail rod and configured to illuminate the surfaces of the model airplane.

3. The illumination system of claim 2, further comprising an LED driver in communication with the plurality of LEDs.

4. The illumination system of claim 3, wherein the wingtip conduit is cylindrical in shape to reduce aerodynamic drag.

5. The illumination system of claim 4, further comprising a wiring harness in communication with a power source, the LED driver, and the electrical wiring to the plurality of LEDs

6. The illumination system of claim 5, wherein the plurality of LEDs are each 3 watt LEDs having at least a 140 viewing angle.

7. The illumination system of claim 6, wherein the power source is a direct current (“DC”) power supply.

8. The illumination system of claim 7, wherein the wingtip conduit is comprised of carbon fiber.

9. The illumination system of claim 8, further comprising a sleeve encapsulating the electrical wiring inside the wingtip conduit that leads to the LEDs.

10. The illumination system of claim 9, wherein the illumination system is removable from the model airplane.

11. The illumination system of claim 10, wherein one 50 watt LED of the plurality LEDs is disposed on each end of the wingtip conduit.

12. The illumination system of claim 11, wherein the LEDs are removable from the wiring harness using electrical connectors.

13. A model airplane illumination system, the system comprising:
a carbon fiber wingtip conduit configured to be secured substantially perpendicular to a wingtip of a model airplane and adapted to house electrical wiring;
a plurality of light emitting diodes (“LED”), wherein at least one LED is secured to each end of the wingtip conduit and configured to illuminate surfaces of the model airplane; and
a carbon fiber tail rod configured to be secures the tail rod to a tail of the airplane and configured to illuminate the surfaces of the airplane; and
at least one light emitting diode (“LED”) of the plurality of LEDs is secured to each end of the tail rod and configured to illuminate the surfaces of the model airplane.

14. The illumination system of claim 13, further comprising an LED driver in communication with the plurality of LEDS.

15. The illumination system of claim 14, wherein the wingtip conduit is cylindrical in shape to reduce aerodynamic drag.

16. The illumination system of claim 15, further comprising a wiring harness in communication with a power source, the LED driver, and the electrical wiring to the plurality of LEDs.

17. The illumination system of claim 16, wherein the power source is a direct current (“DC”) power supply.

18. The illumination system of claim 17, further comprising a plurality of sleeves to encapsulate wiring inside the wingtip conduit and the tail rod that leads to the respective LEDs.

19. The illumination system of claim 18, wherein the illumination system is removable from the model airplane.

20. A model airplane illumination system, the system comprising:
a carbon fiber wingtip conduit configured to be secured substantially perpendicular to a wingtip of a model airplane to illuminate surfaces of the model airplane; and
a carbon fiber tail rod configured to be secured proximate a tail of the model airplane to illuminate the surfaces of the model airplane.
